(19) United States
(12) Patent Application Publication
(10) Pub. No.: US 2026/0241696 A1
(43) Pub. Date: Aug. 20, 2026

(54) PROTECTIVE HOUSING FOR INK CARTRIDGE AND INK CARTRIDGE PACKAGE

(71) Applicant: SPEED INFOTECH (BEIHAI) COMPANY LIMITED, Guangxi (CN)

(72) Inventors: Guantai CHEN, Guangxi (CN); Tangwei YAO, Guangxi (CN); Peijun ZHANG, Guangxi (CN); Zhenli TAN, Guangxi (CN); Xiangmin PAN, Guangxi (CN)

(21) Appl. No.: 19/259,057

(22) Filed: Jul. 3, 2025

(30) Foreign Application Priority Data
Feb. 20, 2025 (CN) 202520272510.8

(51) Int. Cl. B41J 2/175

(52) U.S. Cl. CPC B41J 2/1754; B41J 2/17533; B41J 2/17553; B41J 2/17559

(57) ABSTRACT

The present disclosure provides a protective housing for an ink cartridge and an ink cartridge package. The protective housing comprises an accommodating part and a supporting part connected to the accommodating part. The accommodating part is provided with a first accommodating space configured to accommodate a cartridge body and a second accommodating space configured to accommodate a printing head. The first accommodating space is in communication with the second accommodating space. The supporting part extends in a height direction of the ink cartridge and is arranged adjacent to the second accommodating space for other regions of a bottom surface of the cartridge body to abut against. In addition, the bottom edge of the second accommodating space is lower than the end surface of the printing head, such that a distance is provided between the printing head and the bottom edge of the protective housing, thereby protecting the printing head.

### CROSS-REFERENCE TO RELATED APPLICATIONS

This application claims the right of the priority of Chinese patent application CN202520272510.8, filed on Feb. 20, 2025. The contents of the Chinese patent application are incorporated herein by reference in their entirety.

### TECHNICAL FIELD

The present disclosure relates to a protective housing for an ink cartridge and an ink cartridge package.

### BACKGROUND

Among ink cartridges for daily office use, there is a type of ink cartridge that contains a printing head. The ink in the ink cartridge forms patterns on paper through the printing head according to instructions of a printer. The printing head part in the ink cartridge is a high-precision component that needs to be protected during daily transportation. CN206749276U in the prior art adopts a clipping method for protecting a printing head of an ink cartridge. However, the clipping method is inconvenient to operate, requires a great deal of effort for pulling out from the ink cartridge, and leads to high costs. Another approach, as seen in CN219947661U in the prior art, adopts a package housing designed to accommodate an ink cartridge with a printing head. The overall shape of the housing conforms to the outer contour of the ink cartridge, and a gap is provided at a position of the printing head of the ink cartridge to protect the printing head of the ink cartridge. However, when these two types of protective housings are used for protection, there is still a risk that the ink cartridge may topple over, which will affect the protective effect. In addition, both solutions employ plastic structures to protect the printing head, failing to meet requirements of environmental protection.

### SUMMARY

A technical problem to be solved by the present disclosure is to provide a protective housing for an ink cartridge and an ink cartridge package in order to overcome the above defect in the prior art that the protection is affected by the tilt of the ink cartridge.

The present disclosure solves the above technical problem through the following technical solutions.

A protective housing for an ink cartridge is provided. The ink cartridge comprises a cartridge body and a printing head, and the printing head protrudes from a partial region of a bottom surface of the cartridge body, where
the protective housing comprises an accommodating part and a supporting part connected to the accommodating part, the accommodating part is provided with a first accommodating space configured to accommodate the cartridge body and a second accommodating space configured to accommodate the printing head, and the first accommodating space is in communication with the second accommodating space;
the supporting part extends in a height direction of the ink cartridge and is arranged adjacent to the second accommodating space for other regions of the bottom surface of the cartridge body to abut against; and
at least a part of a bottom edge of the supporting part is flush with a bottom edge of the second accommodating space; and in the height direction of the ink cartridge, the bottom edge of the second accommodating space is lower than an end surface of the printing head.

In this solution, the supporting part supports the other regions of the bottom surface of the cartridge body except for the printing head in the height direction of the ink cartridge, and at least a part of the bottom edge of the supporting part is flush with the bottom edge of the second accommodating space, such that the protective housing can render support in both the printing head region and the other regions of the ink cartridge, preventing the ink cartridge from tilting. In addition, the bottom edge of the second accommodating space is lower than the end surface of the printing head, such that a distance is provided between the printing head and the bottom edge of the protective housing, thereby protecting the printing head.

Preferably, the protective housing is formed by folding a sheet to form the accommodating part and the supporting part, and the supporting part is formed by folding a partial structure of the sheet inward in a direction close to the second accommodating space.

In this solution, the protective housing is formed by folding the sheet, and the supporting part can be formed by folding the partial structure of the sheet inward, thereby facilitating manufacturing and formation of the protective housing.

Preferably, the sheet comprises a plurality of plates arranged in sequence, a head end plate located at a head end and a tail end plate located at a tail end are connectable to each other; at least one of the plurality of plates is provided with an in-folding portion, and a cut is provided between the in-folding portion and other portion of the plate.

In this solution, after the head end plate and the tail end plate are connected to each other, an accommodating space for accommodating an ink cartridge can be formed in an enclosed manner. The supporting part can be formed by using a partial structure of one or more plates as the in-folding portion. In addition, on the plate provided with the in-folding portion, the cut is provided between the in-folding portion and the other portion, such that the in-folding portion can be folded inward.

Preferably, on the plate provided with the in-folding portion, the cut is provided on the plate at a position flush with the bottom surface of the cartridge body.

In this solution, the cut is provided at the position flush with the bottom surface of the cartridge body, which achieves match with the height of the bottom surface of the cartridge body. Moreover, when no cut is provided in other regions, the in-folding portion is connected to the other portion of the plate, enabling more reliable bearing of the supporting part.

Preferably, the sheet comprises a first plate, a second plate, a third plate, and a fourth plate that are arranged in sequence, and the first plate and the fourth plate are connectable to each other; each of the third plate and the fourth plate is provided with the in-folding portion, and the cut is provided between the in-folding portion and other portion of each of the third plate and the fourth plate.

Preferably, a crease extending in the height direction of the ink cartridge is provided between two adjacent plates among the first plate, the second plate, the third plate, and the fourth plate; and a crease extending in the height direction of the ink cartridge is provided between the in-folding portion and the corresponding other portion of the third plate and the fourth plate.

Preferably, the sheet further comprises a connecting plate, and the connecting plate is located at a side of one of the head end plate and the tail end plate and is bonded to the other one of the head end plate and the tail end plate.

Preferably, the protective housing is formed by mould pressing.

Preferably, a projection of the supporting part on the bottom surface of the cartridge body is L-shaped.

Preferably, the protective housing is made of a paper material or a plastic cement material.

In this solution, when the sheet is made of the paper material, it offers environmental benefits and further facilitates the printing of required information on the surface of the protective housing, for example, the printing of local eco-labels depending on different sales regions. When the sheet is made of the plastic cement material, the plastic cement material may be in a transparent form, thereby facilitating observation of the ink cartridge, such as a part of the surface of the ink cartridge carrying information of the ink cartridge.

Preferably, the distance between the bottom edge of the second accommodating space and the end surface of the printing head ranges from 6 mm to 10 mm.

Preferably, a dimension of a top part of the first accommodating space is smaller than a dimension of a flange at a top part of the ink cartridge.

In this solution, a top edge of the protective housing can assist in supporting the flange at the top part of the ink cartridge, thereby further improving the protective effect.

Preferably, a groove is provided at a top part of the accommodating part, and the groove is configured to accommodate a locking structure of the ink cartridge.

In this solution, the groove can support the locking structure of the ink cartridge, thereby further improving the protective effect of the protective housing.

Preferably, the groove is recessed downward from a top edge of the accommodating part.

Preferably, the accommodating part is provided with a window on a side wall of the first accommodating space, and a position of the window on the side wall is configured to align with a component carrying identity information of the ink cartridge.

In this solution, the window can expose the component carrying the identity information (ID) of the ink cartridge, thereby facilitating a user to see the identity information (ID) of the ink cartridge without removing the ink cartridge from the protective housing.

An ink cartridge package is further provided. The ink cartridge package comprises the protective housing for an ink cartridge as described above.

Preferably, the ink cartridge package further comprises an outer packaging member, where at least one of the protective housing is provided in the outer packaging member, and the protective housing is configured to accommodate an ink cartridge.

The positive and progressive effects of the present disclosure are as follows. The supporting part supports the other regions of the bottom surface of the cartridge body except for the printing head in the height direction of the ink cartridge, and at least a part of the bottom edge of the supporting part is flush with the bottom edge of the second accommodating space, such that the protective housing can render support in both the printing head region and the other regions of the ink cartridge, preventing the ink cartridge from tilting. In addition, the bottom edge of the second accommodating space is lower than the end surface of the printing head, such that a distance is provided between the printing head and the bottom edge of the protective housing, thereby protecting the printing head.

### BRIEF DESCRIPTION OF THE DRAWINGS

FIG. 1 is a schematic structural diagram of an ink cartridge;

FIG. 2 is a schematic structural diagram of a protective housing according to Embodiment 1;

FIG. 3 is a schematic structural diagram of an ink cartridge package with an ink cartridge accommodated in a protective housing;

FIG. 4 is a sectional plan view of the ink cartridge package in FIG. 3;

FIG. 5 is a sectional perspective view of the ink cartridge package in FIG. 3;

FIG. 6 is a bottom view of the ink cartridge package in FIG. 3;

FIG. 7 is a schematic structural diagram of a sheet according to Embodiment 1;

FIG. 8 is another schematic structural diagram of the bottom of a protective housing;

FIG. 9 is a schematic structural diagram of a protective housing according to Embodiment 2; and

FIG. 10 is a schematic structural diagram of a protective housing according to Embodiment 3.

### DESCRIPTION OF THE REFERENCE NUMERALS

protective housing 10, accommodating part 100, first accommodating space 110, top edge 111, second accommodating space 120, bottom edge of the second accommodating space 121, groove 130, window 140, supporting part 200, bottom edge of the supporting part 211, sheet 300, first plate 310, second plate 320, third plate 330, first in-folding portion 331, fourth plate 340, second in-folding portion 341, cut 350, connecting plate 360, ink cartridge 20, cartridge body 21, other regions of a bottom surface of the cartridge body 201, flange 202, locking structure 203, printing head 22, upper cover 23, ink cartridge QR code 24, protective film 30, height direction H, length direction L, width direction W, and distance D of the ink cartridge.

### DETAILED DESCRIPTION OF THE PREFERRED EMBODIMENTS

The present disclosure is further illustrated by the following embodiments; however, these embodiments should not be construed as limiting the present disclosure.

### Embodiment 1

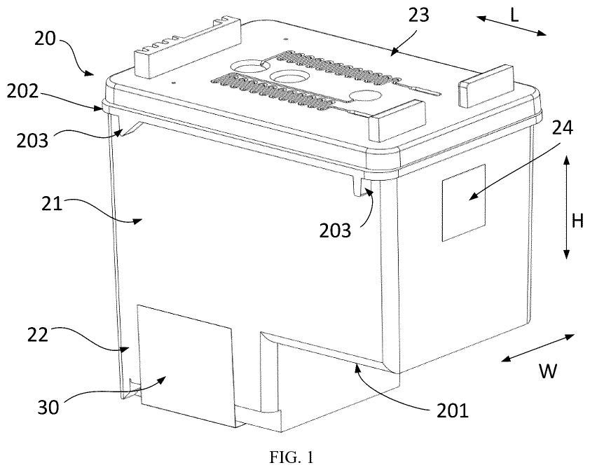

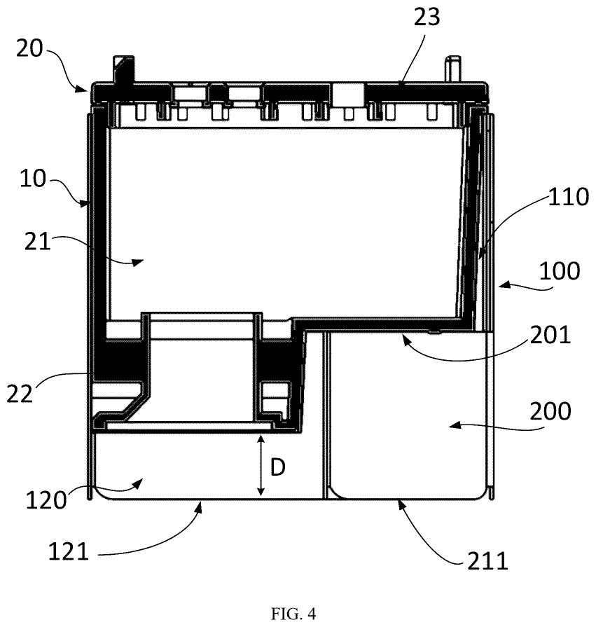

An embodiment of the present disclosure provides a protective housing 10 for an ink cartridge 20. As shown in FIG. 1, the ink cartridge 20 comprises a cartridge body 21 and a printing head 22. In a height direction H of the ink cartridge 20, the printing head 22 protrudes from a partial region of a bottom surface of the cartridge body 21 and is located at a side (a left side in a length direction L shown in FIG. 1) of the bottom surface of the cartridge body 21, such that for the entire ink cartridge 20, an uneven structural form is formed at the bottom of the ink cartridge. The convex portion is the region where the printing head 22 is located, and other regions except for the printing head 22 form a concave structural form. Generally, the other regions of the bottom surface of the cartridge body 201 are substantially a flat surface. As shown in FIG. 4, an upper cover 23 is further connected to a top part of the cartridge body 21, and the upper cover 23 is fixed on the cartridge body 21 through welding or glue bonding.

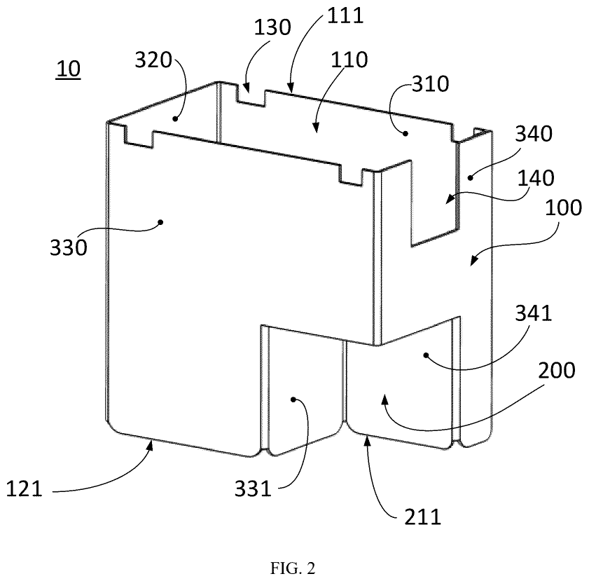

As shown in FIGS. 2-6, the protective housing 10 comprises an accommodating part 100 and a supporting part 200 connected to the accommodating part 100. The accommodating part 100 is provided with a first accommodating space 110 configured to accommodate the cartridge body 21 and a second accommodating space 120 configured to accommodate the printing head 22. The first accommodating space 110 is in communication with the second accommodating space 120. The supporting part 200 extends in the height direction H of the ink cartridge 20 and is arranged adjacent to the second accommodating space 120 for the other regions of the bottom surface of the cartridge body 201 to abut against. At least a part of a bottom edge 211 of the supporting part 200 is flush with a bottom edge of the second accommodating space 121. In the height direction H of the ink cartridge 20, the bottom edge of the second accommodating space 121 is lower than an end surface of the printing head 22.

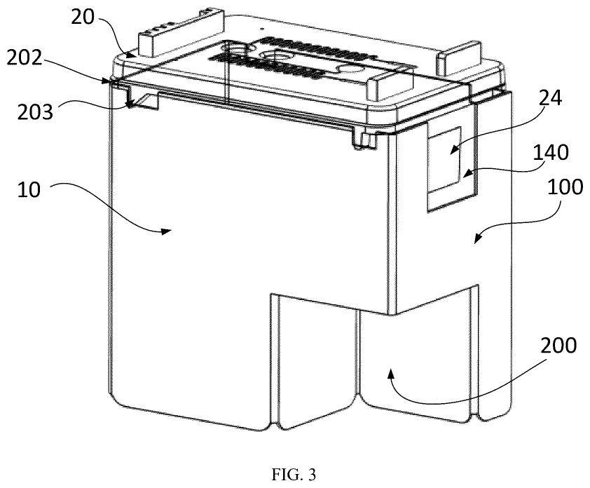

In the directions shown in FIGS. 2-6, the first accommodating space 110 is located above the second accommodating space 120. The first accommodating space 110 surrounds an outer side wall of the cartridge body 21. The depth of the first accommodating space 110 and the dimension of the cartridge body 21 in the height direction H of the ink cartridge 20 may be configured as required. In some cases, the depth of the first accommodating space 110 is greater than the dimension of the cartridge body 21 in the height direction H of the ink cartridge 20. In other cases, the depth of the first accommodating space is lower than the dimension of the cartridge body in the height direction H of the ink cartridge. Preferably, as shown in FIGS. 3, 4, and 5, the depth of the first accommodating space 110 is substantially the same as the dimension of the cartridge body 21 in the height direction H of the ink cartridge 20. When the top part of the cartridge body 21 is provided with a flange 202, the depth is slightly lower than the dimension of the cartridge body 21 in the height direction H of the ink cartridge 20.

As shown in FIGS. 2-6, the second accommodating space 120 surrounds an outer side of the printing head 22, and the depth of the second accommodating space 120 is greater than the dimension of the printing head 22 in the height direction H of the ink cartridge 20, such that a distance D is provided between the printing head 22 and the bottom edge 121, thereby protecting the printing head 22. In addition, the distance D can also play a buffering role during transportation or accidental drops. Even if the bottom edge of the protective housing 10 is deformed, the distance D prevents the printing head 22 from being damaged. The supporting part 200 supports the other regions of the bottom surface of the cartridge body 201, and at least a part of the bottom edge 211 of the supporting part 200 is flush with the bottom edge of the second accommodating space 121, such that the bottom edge of the protective housing 10 can be placed stably and the ink cartridge 20 can be suspended in the air. As shown in FIG. 4, preferably, the bottom edge 211 of the supporting part 200 is substantially entirely flush with the bottom edge of the second accommodating space 121. In other embodiments, the bottom edge of the supporting part 200 may also be partially higher than the bottom edge of the second accommodating space 121.

The structural form of the protective housing 10 for an ink cartridge 20 provided above also facilitates the implementation of manufacturing and formation. The protective housing 10 can be formed by folding a sheet 300 to form the accommodating part 100 and the supporting part 200, and the supporting part 200 is formed by folding a partial structure of the sheet 300 inward in a direction close to the second accommodating space 120.

The sheet 300 is made of a paper material or a plastic cement material. When the sheet 300 is made of the paper material, it offers environmental benefits—particularly in light of plastic restriction policies in many countries—as well as cost advantages, and further facilitates the printing of required information on the surface of the protective housing 10, for example, the printing of local eco-labels depending on different sales regions. When the sheet 300 is made of the plastic cement material, the plastic cement material may be in a transparent form, thereby facilitating observation of the ink cartridge 20, such as a part of the surface of the ink cartridge 20 carrying information of the ink cartridge.

The sheet 300 comprises a plurality of plates arranged in sequence, a head end plate located at a head end and a tail end plate located at a tail end are connectable to each other. At least one of the plurality of plates is provided with an in-folding portion, and a cut 350 is provided between the in-folding portion and other portion of the plate. The number of the plates is related to the number of circumferential side walls of the ink cartridge 20. As a conventional form of the ink cartridge 20, as shown in FIG. 1, the ink cartridge 20 is provided with four circumferential side walls. Correspondingly, the sheet 300 may comprise four main plates corresponding to the circumferential side walls of the ink cartridge 20. After the head end plate and the tail end plate are connected to each other, the accommodating space formed in an enclosed manner can be adapted to the structure of the ink cartridge 20. The sheet 300 may be of an integral sheet structure, a crease may be provided between the plates, and a crease may be further provided between the in-folding portion and other portion of the plate except for the position of the cut 350, so as to facilitate the folding of the sheet 300 to form the protective housing 10.

When one or more plates are selected from the plurality of plates for configuring the in-folding portion, the selection may be performed based on a positional relationship of the above concave portion of the ink cartridge 20. The plates correspond to the concave portion in the height direction H and the length direction L of the ink cartridge 20, or in the height direction H and the width direction W of the ink cartridge 20. In addition, when the dimension of the in-folding portion is defined on the corresponding plates, the dimension may also be defined with reference to the dimension of the concave portion of the ink cartridge 20. The cut 350 is provided between the in-folding portion and the other portion, such that the in-folding portion is separated from the other portion at the cut 350 and is folded inward. In this way, the supporting part 200 formed by folding the in-folding portion inward can abut against the other regions of the bottom surface of the cartridge body 201, and the second accommodating space 120 can also be defined by folding the in-folding portion inward.

On the plate provided with the in-folding portion, the cut 350 is provided on the plate at a position flush with the bottom surface of the cartridge body 21. The cut 350 is provided at the position flush with the bottom surface of the cartridge body 21, which achieves match with the height of the bottom surface of the cartridge body 21. Moreover, when no cut 350 is provided in other regions, the in-folding portion is connected to the other portion of the plate, enabling more reliable bearing of the supporting part 200.

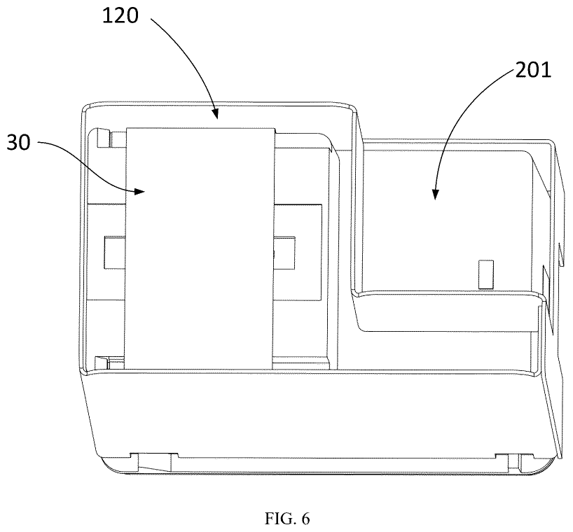

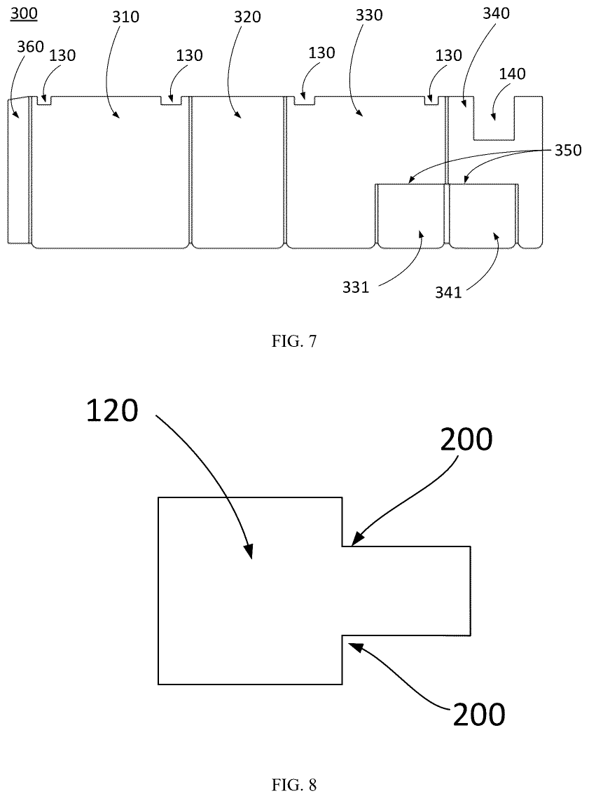

With the ink cartridge 20 being provided with four circumferential side walls as an example, FIG. 7 shows a structural form of the sheet 300. After the sheet 300 is enclosed and folded inward, a form of the protective housing 10 shown in FIG. 2 can be formed. As shown in FIGS. 3-6, the protective housing can be arranged at a circumferential outer side of the ink cartridge 20 to protect the ink cartridge 20. The sheet 300 comprises a first plate 310, a second plate 320, a third plate 330, and a fourth plate 340 that are arranged in sequence. The first plate 310 located at the head end and the fourth plate 340 located at the tail end are connectable to each other. Each of the third plate 330 and the fourth plate 340 is provided with the in-folding portion, i.e., a first in-folding portion 331 and a second in-folding portion 341. The cut 350 is provided between the first in-folding portion 331 and other portion of the third plate 330, and between the second in-folding portion 341 and other portion of the fourth plate 340.

As shown in FIGS. 3-5, both the first plate 310 and the third plate 330 are sized to adapt to the length of the ink cartridge 20, and both the second plate 320 and the fourth plate 340 are sized to adapt to the width of the ink cartridge 20. The cut 350 is provided between the first in-folding portion 331 and the other portion of the third plate 330 only at a position flush with the bottom surface of the ink cartridge 20, and the cut 350 is provided between the second in-folding portion 341 and the other portion of the fourth plate 340 only at a position flush with the bottom surface of the ink cartridge 20. The two cuts 350 are on the same line.

As shown in FIG. 7, a crease extending in the height direction H of the ink cartridge 20 is provided between two adjacent plates among the first plate 310, the second plate 320, the third plate 330, and the fourth plate 340; and a crease extending in the height direction H of the ink cartridge 20 is provided between the in-folding portion and the corresponding other portion of the third plate 330 and the fourth plate 340.

As a connection mode for the head end plate and the tail end plate, the sheet 300 further comprises a connecting plate 360. The connecting plate 360 is located at a side of one of the head end plate and the tail end plate and is bonded to the other one of the head end plate and the tail end plate. As shown in FIG. 7, the connecting plate 360 is located at a side of the first plate 310. A crease extending in the height direction H of the ink cartridge 20 is provided between the connecting plate and the first plate 310. The connecting plate 360 is configured to be bonded to the fourth plate 340.

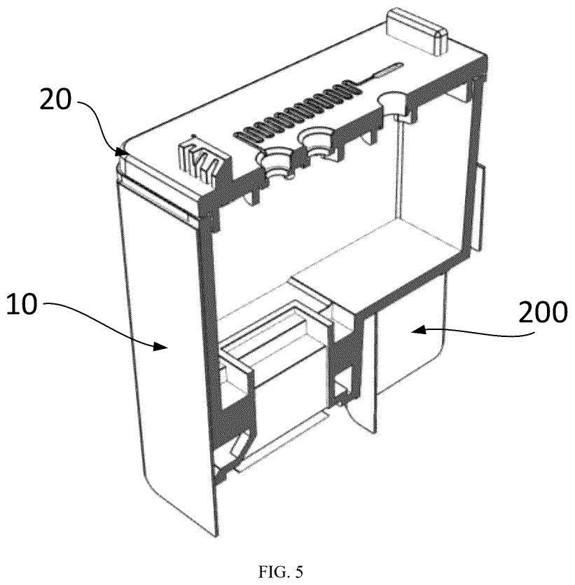

Both the dimension occupied by the first in-folding portion 331 on the third plate 330 and the dimension occupied by the second in-folding portion 341 on the fourth plate 340 are smaller than those of the plates 330 and 340. Specifically, the height dimension of the first in-folding portion 331 is flush with the bottom surface of the cartridge body 21, and the width dimension of the first in-folding portion is smaller than the width of the third plate 330, such that a plate portion required by the second accommodating space 120 can be reserved. The height dimension of the second in-folding portion 341 is flush with the bottom surface of the cartridge body 21, and the width dimension of the second in-folding portion is preferably smaller than the width of the fourth plate 340. As shown in FIG. 6, the bottom surface of the cartridge body 21 can be supported at more positions.

As shown in FIG. 6, a projection of the first in-folding portion 331 and the second in-folding portion 341 as a whole on the bottom surface of the cartridge body 21 is L-shaped. According to an actual requirement, the projection of the in-folding portion on the bottom surface of the cartridge body 21 may also have another shape. For example, as shown in FIG. 8, an L-shaped supporting part 200 is formed at each of two corners of the protective housing 10. When the sheet 300 is made of the paper material, the overall length of the in-folding portion is related to the utilized portion of the sheet 300. When the sheet 300 is made of the plastic cement material, the projection may be in a Z shape (not shown) or another shape in addition to the foregoing shapes.

As shown in FIGS. 1 and 3, the top part of the ink cartridge 20 is provided with the flange 202. Specifically, the flange 202 is circumferentially arranged on the outer side of the top part of the cartridge body 21. The dimension of the first accommodating space 110 is substantially the same as the circumferential dimension of the cartridge body 21. As shown in FIGS. 3 and 4, the dimension of the top part of the first accommodating space 110 is smaller than the dimension of the flange 202 at the top part of the ink cartridge 20. A top edge 111 of the protective housing 10 can assist in supporting the flange 202 at the top part of the ink cartridge 20, thereby further improving the protective effect.

As shown in FIGS. 1 and 3, a locking structure 203 is further provided at the top part of the ink cartridge 20, and the supporting effect can be further improved by supporting the locking structure 203. Specifically, as shown in FIG. 2, a groove 130 is provided at a top part of the accommodating part 100, and the groove 130 is configured to accommodate the locking structure 203 of the ink cartridge 20. Different ink cartridges 20 may have different locking structures 203. As shown in FIGS. 1 and 2, the locking structure 203 is provided on each of two opposite sides of the ink cartridge 20, and one or more locking structures 203 may be provided on each side. Correspondingly, the groove 130 is provided at each position corresponding to the locking structure 203. In other embodiments, the locking structure 203 is provided on only one side of the ink cartridge 20.

The groove 130 is preferably recessed downward from the top edge 111 of the accommodating part 100. In other embodiments, the groove 130 may also penetrate the plate at the top part of the accommodating part 100, rendering support at a lower edge of the groove 130 and limit at an upper edge of the groove 130.

The distance D between the bottom edge of the second accommodating space 121 and the end surface of the printing head 22 ranges from 6 mm to 10 mm. The distance D may be configured based on the weight of the ink cartridge 20, support of the flange 202 at the top part of the ink cartridge 20 by the top edge 111 of the protective housing 10, and support of the locking structure 203 by the groove 130.

As shown in FIG. 1, a component carrying identity information of the ink cartridge 20, which is generally an ink cartridge QR code 24, is generally provided on the surface of the ink cartridge 20. The QR code 24 is generally located at the tail part of the ink cartridge 20. Information such as the manufacturing date, batch number, and ink type of the ink cartridge 20 can be learned by scanning the QR code 24. As shown in FIGS. 2 and 3, the accommodating part 100 is provided with a window 140 on a side wall of the first accommodating space, and a position of the window 140 on the side wall is configured to align with the component carrying the identity information of the ink cartridge 20. As shown in FIG. 7, the window 140 is provided at a top part of the fourth plate 340.

### Embodiment 2

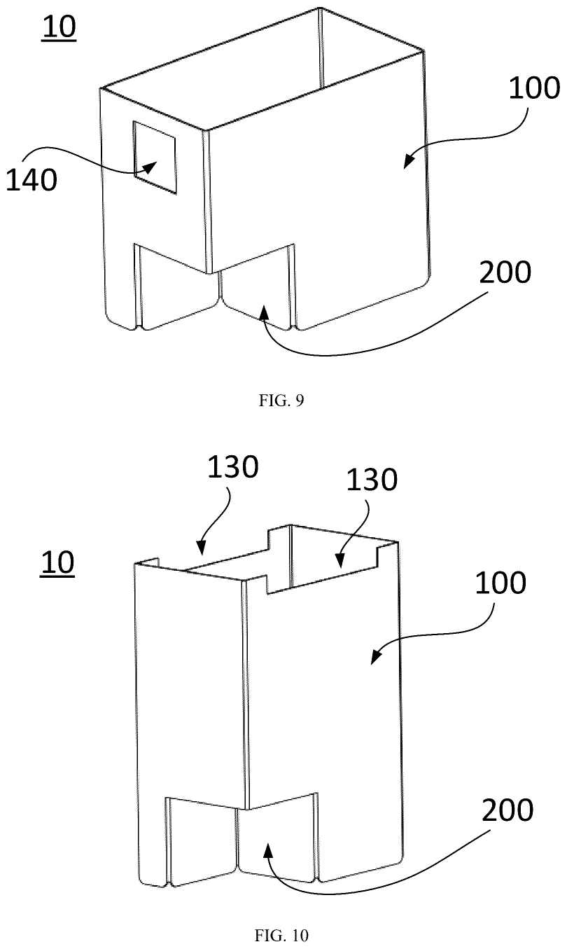

In Embodiment 1, a protective housing 10 for an ink cartridge 20 is provided. The protective housing 10 is provided with a supporting part 200, and is further provided with a groove 130 for engaging with a locking structure 203, and an observation window 140. The concept of this embodiment is substantially the same as that of Embodiment 1, with a difference lying in that, as shown in FIG. 9, the protective housing 10 of this embodiment is provided with a supporting part 200 and an observation window 140, but no groove 130 is provided on a top edge 111 of the protective housing 10.

### Embodiment 3

The concept of this embodiment is substantially the same as that of Embodiment 1, with a difference lying in that, as shown in FIG. 10, the protective housing 10 of this embodiment is provided with a supporting part 200 and a groove 130 for engaging with a locking structure 203, but no window 140 is provided on a side wall of the protective housing 10. As shown in FIG. 10, a groove 130 is provided on each of two opposite side walls of the protective housing 10, and the groove 130 is in a long strip shape.

### Embodiment 4

In Embodiment 1, an embodiment in which a protective housing is formed by folding a sheet 300 is provided, which can be used to manufacture and form any one of the protective housings in Embodiments 1-3 as described above. In this embodiment, another method for manufacturing and forming a protective housing is provided, which can also be used to manufacture and form any one of the protective housings in Embodiments 1-3 as described above. Specifically, the protective housing is formed by mould pressing. The materials used for pressing may be a paper material and a plastic material.

The paper material in Embodiment 1 and this embodiment may be specifically made of, for example but without limitation, recycled pulp or raw wood pulp. The recycled pulp is derived from waste paper (such as newspapers and magazines) and is low in cost and environmentally friendly. The raw wood pulp is made of wood fibers and has better strength and durability.

The plastic cement or plastic material in Embodiment 1 and this embodiment may be specifically made of, for example but without limitation, materials such as polystyrene (PS), polyethylene (PE), or polypropylene (PP). These materials have good water resistance and durability.

In addition, it may also be made of degradable materials, which are generally made of materials such as pulp, corn starch, bamboo fibers, or bioplastics. These materials are not only environmentally friendly but also biodegradable in the natural environment, reducing pollution to the environment.

### Embodiment 5

This embodiment provides an ink cartridge package. As shown in FIG. 3, the ink cartridge package comprises the protective housing 10 for an ink cartridge 20 in any one of Embodiments 1-4 as described above.

The ink cartridge package further comprises an outer packaging member (not shown). At least one protective housing 10 is provided in the outer packaging member, and the protective housing 10 is configured to accommodate an ink cartridge 20. Specifically, the outer packaging member may be a component such as a paper shell or a plastic packaging film. Generally, the outer packaging member is configured to encapsulate a plurality of protective housings.

As shown in FIGS. 1 and 6, the printing head 22 is further covered with a protective film 30. The protective film 30 can prevent ink leakage, dust, ink drying, and the like, while also providing general protection for the printing head 22.

Although the specific implementation of the present disclosure has been described above, those skilled in the art should understand that this is only an example, and the scope of protection of the present disclosure is limited by the appended claims. Those skilled in the art may make a variety of changes or modifications to these embodiments without departing from the principles and substance of the present disclosure, and all such changes and modifications should fall within the protection scope of the present disclosure.

What is claimed is:

1. A protective housing for an ink cartridge, the ink cartridge comprising a cartridge body and a printing head, and the printing head protruding from a partial region of a bottom surface of the cartridge body, wherein
the protective housing comprises an accommodating part and a supporting part connected to the accommodating part, the accommodating part is provided with a first accommodating space configured to accommodate the cartridge body and a second accommodating space configured to accommodate the printing head, and the first accommodating space is in communication with the second accommodating space;
the supporting part extends in a height direction of the ink cartridge and is arranged adjacent to the second accommodating space for other regions of the bottom surface of the cartridge body to abut against; and
at least a part of a bottom edge of the supporting part is flush with a bottom edge of the second accommodating space; and in the height direction of the ink cartridge, the bottom edge of the second accommodating space is lower than an end surface of the printing head.

2. The protective housing for an ink cartridge according to claim 1, wherein the protective housing is formed by folding a sheet to form the accommodating part and the supporting part, and the supporting part is formed by folding a partial structure of the sheet inward in a direction close to the second accommodating space.

3. The protective housing for an ink cartridge according to claim 2, wherein the sheet comprises a plurality of plates arranged in sequence, a head end plate located at a head end and a tail end plate located at a tail end are connectable to each other; at least one of the plurality of plates is provided with an in-folding portion, and a cut is provided between the in-folding portion and other portion of the plate.

4. The protective housing for an ink cartridge according to claim 3, wherein on the plate provided with the in-folding portion, the cut is provided on the plate at a position flush with the bottom surface of the cartridge body.

5. The protective housing for an ink cartridge according to claim 3, wherein the sheet comprises a first plate, a second plate, a third plate, and a fourth plate that are arranged in sequence, and the first plate and the fourth plate are connectable to each other; each of the third plate and the fourth plate is provided with the in-folding portion, and the cut is provided between the in-folding portion and other portion of each of the third plate and the fourth plate.

6. The protective housing for an ink cartridge according to claim 5, wherein a crease extending in the height direction of the ink cartridge is provided between two adjacent plates among the first plate, the second plate, the third plate, and the fourth plate; and a crease extending in the height direction of the ink cartridge is provided between the in-folding portion and corresponding other portion of the third plate and the fourth plate.

7. The protective housing for an ink cartridge according to claim 3, wherein the sheet further comprises a connecting plate, and the connecting plate is located at a side of one of the head end plate and the tail end plate and is bonded to the other one of the head end plate and the tail end plate.

8. The protective housing for an ink cartridge according to claim 1, wherein the protective housing is formed by mould pressing.

9. The protective housing for an ink cartridge according to claim 1, wherein the protective housing is configured to meet at least one of the following:
a projection of the supporting part on the bottom surface of the cartridge body is L-shaped;
the protective housing is made of a paper material or a plastic cement material;
the distance between the bottom edge of the second accommodating space and the end surface of the printing head ranges from 6 mm to 10 mm.

10. The protective housing for an ink cartridge according to claim 1, wherein a dimension of a top part of the first accommodating space is smaller than a dimension of a flange at a top part of the ink cartridge.

11. The protective housing for an ink cartridge according to claim 1, wherein a groove is provided at a top part of the accommodating part, and the groove is configured to accommodate a locking structure of the ink cartridge.

12. The protective housing for an ink cartridge according to claim 11, wherein the groove is recessed downward from a top edge of the accommodating part.

13. The protective housing for an ink cartridge according to claim 1, wherein the accommodating part is provided with a window on a side wall of the first accommodating space, and a position of the window on the side wall is configured to align with a component carrying identity information of the ink cartridge.

14. An ink cartridge package, wherein the ink cartridge package comprises the protective housing for an ink cartridge according to claim 1.

15. The ink cartridge package according to claim 14, wherein the ink cartridge package further comprises an outer packaging member, wherein at least one of the protective housing is provided in the outer packaging member, and the protective housing is configured to accommodate an ink cartridge.
